(19) United States
(12) Patent Application Publication
(10) Pub. No.: US 2006/0151252 A1
(43) Pub. Date: Jul. 13, 2006

(54) Heavy duty vehicle component lift apparatus and method

(75) Inventor: Rodd Joos, Lauderdale, MN (US)

Correspondence Address: BAKER & HOSTETLER LLP;Washington Square, Suite 1100, 1050 Connecticut Avenue, N.W., WASHINGTON, DC, 20036, US

(73) Assignee: SPX Corporation

(21) Appl. No.: 10/976,789

(22) Filed: Nov. 1, 2004

(51) Int. Cl. B66B 9/02

(52) U.S. Cl. 187/269

(57) ABSTRACT

A heavy duty vehicle component lift apparatus and method for supporting and lifting components is provided. The invention includes a lift extension connected to a frame assembly and a lift table. A hydraulic cylinder and ram assembly extends and contracts the lift extension. The lift table may be tiltably adjustable in a first and second direction.

### FIELD OF THE INVENTION

The present invention relates generally to vehicle servicing equipment and method of use. More particularly, the present invention relates to heavy duty lifting apparatus and method for the automotive and/or heavy-duty truck service industry.

### BACKGROUND OF THE INVENTION

Many automotive and commercial vehicles used for commercial trucking, transportation, and the like utilize engines and transmission assemblies incorporated into their vehicle design. Such assemblies, commonly known as powertrain assemblies need to be installed and furthermore, after a period of use, may require maintenance and repair. Because of the size, weight, and confined space in which a mechanic may work, handling of such assemblies to maneuver into a convenient orientation can be strenuous or could run a risk of imposing difficulty to a mechanic. The aforementioned is becoming more apparent, for example, as automobiles become more aerodynamic and/or stylized. Hence, access through the hood opening is often too small to remove, install and/or service the powertrain assembly for such vehicles.

Typically, when servicing the powertrain assembly, a mechanic may lift an entire vehicle a limited distance off the ground. However, due to newer car designs, for example, clearance access from below may require greater ground clearances to access the powertrain assembly. A problem exists, such that current lift designs do not cover such clearance distances from the ground. Furthermore, additional problems exist for supporting the large sizes and weights of modern engine and transmission assembly designs.

Conventional lifts are typically restricted to only limited vertical lifting capability to assist the mechanic in positioning vehicle engine or transmission components. A lift having only limited vertical lifting capability requires a mechanic, in many instances, to crouch or bend over to have access to engine or transmission components in order for removal or servicing operations. This may require the mechanic to conform to contorted, stooped, or bent positions while working. These positions can contribute to fatigue and/or injury stemming from exerting force, for example, from an anatomically awkward position. For lifts having only limited vertical lifting capability, a mechanic may need to compensate for servicing engine and transmission assemblies at an additional height from the lift itself. This task can waste valuable service time and also impose a challenge for locating the engine and transmission assemblies from the lift into position.

Accordingly, it is desirable to provide a method and apparatus that provides a power assisted lift including, for example, extended distances to support engines/transmissions or powertrain assemblies during assembly and removal operations. It is further desirable to provide a method and apparatus for adjusting such assemblies on the lift thereby enhancing aligning capabilities of the lift in order to more easily locate powertrain assemblies into position while also alleviating the necessity for a mechanic to work in contorted or uncomfortable positions.

### SUMMARY OF THE INVENTION

The foregoing needs are met, to a great extent, by the present invention, wherein in one aspect an apparatus is provided that in some embodiments comprises a main frame assembly, and a lift carriage slidably converted to the main frame assembly. The lift carriage may be laterally adjustable with respect to the main frame assembly. The apparatus may further provide a hydraulic cylinder and ram assembly located or the main frame assembly and be further coupled to the lift carriage.

In accordance with another aspect of the present invention, a method is provided that in some embodiments provides a first frame assembly and couples a lift extension to the first frame assembly. The method may also include coupling a lift table to the lift extension and extending and/or retracting the lift extension via a hydraulic cylinder and ram assembly.

In accordance with yet another aspect of the present invention, a system is provided that in some embodiments comprises a first means for supporting, a means for lifting connected to the first supporting means, a second means for supporting connected to the lifting means and a means for extending the lifting means connected to the first support means and further coupled to the lifting means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a heavy duty vehicle component lift apparatus according to a preferred embodiment of the invention.

FIG. 2 is a perspective view of the heavy duty vehicle component lift apparatus of FIG. 1 shown in a less extended position.

FIG. 3 is a front view of the heavy duty vehicle component lift apparatus of FIG. 2.

FIG. 4 is a left side view of the heavy duty vehicle component lift apparatus of FIG. 2.

FIG. 5. is a rear view of the heavy duty vehicle component lift apparatus of FIG. 2.

FIG. 6. is a top view of the heavy duty vehicle component lift apparatus of FIG. 2.

FIG. 7 is a right side view of the heavy duty vehicle component lift apparatus of FIG. 2.

FIG. 8 is a bottom view of the heavy duty vehicle component lift apparatus of FIG. 2.

### DETAILED DESCRIPTION

An embodiment in accordance with the present invention provides a heavy duty vehicle component lift apparatus and method which features receiving and lifting loads over extended distances to service vehicles. Another embodiment in accordance with the present invention provides a configuration of a heavy duty vehicle component lift apparatus and method having an adjusting feature. Preferred embodiments of the invention will now be described with reference to the drawing figures, in which like reference numerals refer to like parts throughout.

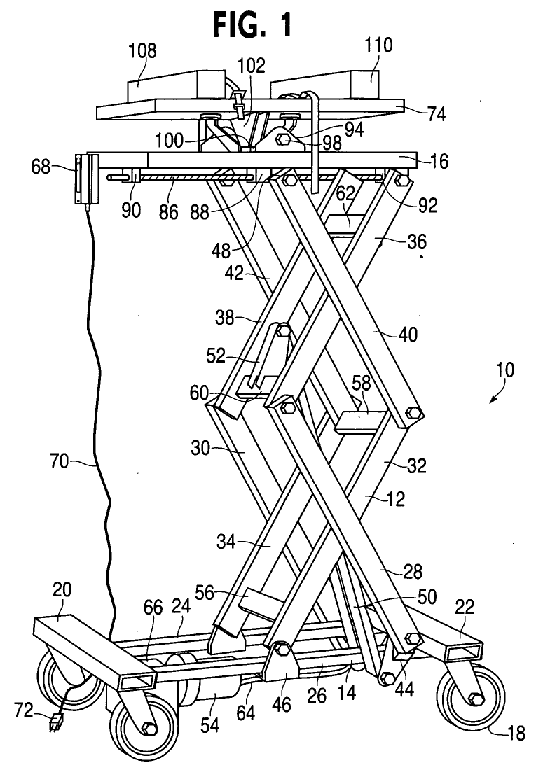

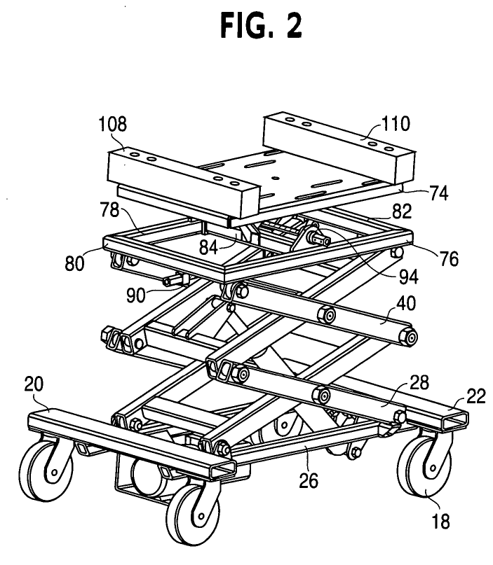

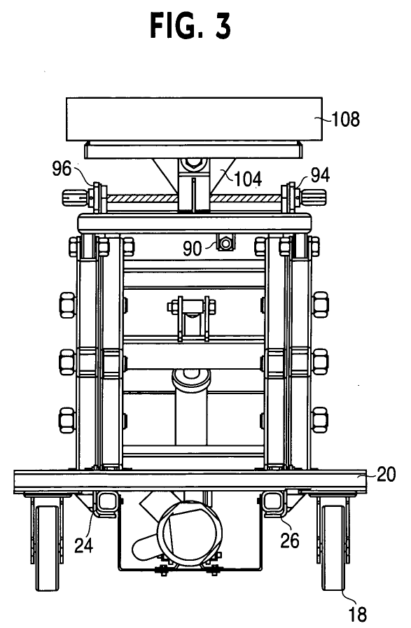

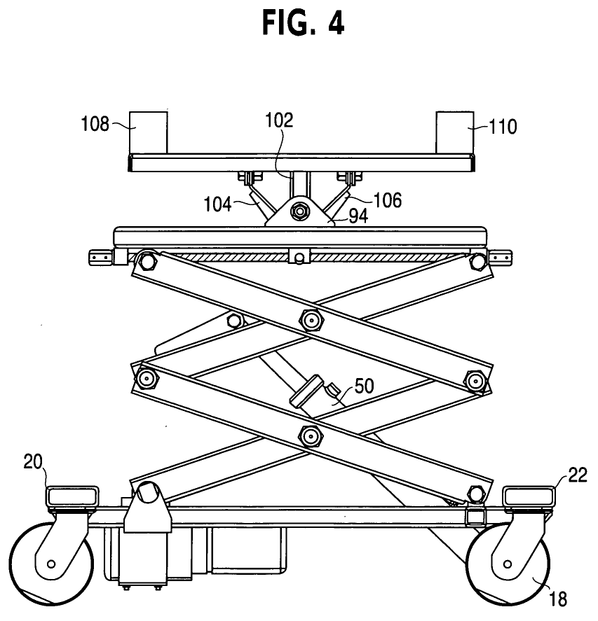

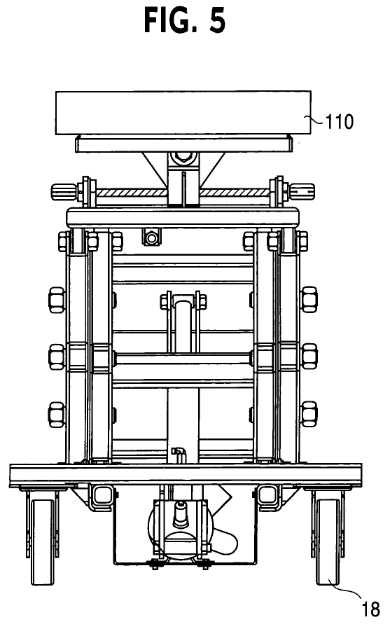

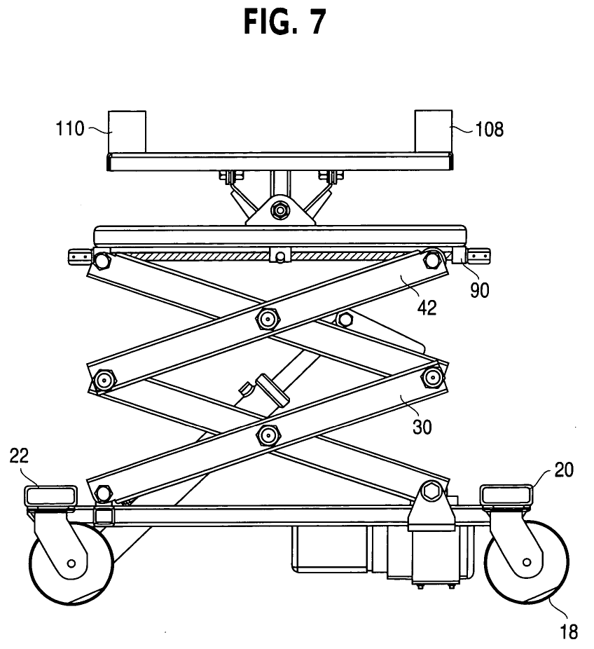

An embodiment of the present inventive apparatus is illustrated in FIG. 1 wherein a heavy duty vehicle component lift apparatus 10 is shown. In the preferred embodiment, the heavy duty vehicle component lift apparatus 10 may generally include an extending means such as a scissors type extension 12 coupled to a support frame 14 at one end and a lift platform 16 at another end. Preferred materials of the scissors type extension 12 and/or the support frame 14 may include steel components. The support frame 14 may generally rest upon a plurality of casters 18 for mobility and maneuverability. In a preferred embodiment, 8 inch swivel casters are utilized. Diametrically opposing casters may have a locking feature to hold the heavy duty vehicle component lift apparatus 10 in place. The casters may be attached to forward and rear cross members 20 and 22 of the support frame 14 by bolts or other suitable attachment devices.

In one embodiment, the support frame 14 generally comprises two elongated support members—right support member 24 and left support member 26. Rearward ends of the support members 24, 26 may be rigidly attached to rear cross member 22 such as by weldment. Likewise, forward ends of the support members 24, 26 may be rigidly attached to forward cross member 20 such as by weldment.

In one embodiment, the scissors type extension 12 generally comprises two portions—an upper and lower portion. The lower portion may comprise a plurality of lower leg portions 28, 30, 32, 34. The upper portion may comprises a plurality of upper leg portions 36, 38, 40, 42. In a preferred embodiment, each of the lower leg portions 28, 30, 32, 34 and upper leg portions 36, 38, 40, 42 contain two ends. One end of the lower leg portions 28, 30, 32, 34 is coupled to the support frame 14. The other end of the lower leg portions 28, 30, 32, 34 is coupled to a respective end of the upper leg portions 36, 38, 40, 42, for example by bolts or other suitable attachment devices. The other end of each upper leg portions 36, 38, 40, 42 are either attached or cooperatively operate with lift platform 16 as described herein.

As shown, for instance, in FIG. 1, lower left rearwardly projecting leg 28 and lower right rearwardly projected leg 30 are connected to left support member 26 and right support member 24 respectively. By way of example, such connection may include a bolt connection extending through lower ends of the left rearwardly projecting leg 28 and lower right rearwardly projected leg 30 and respective flange members 44 connected to left support member 26 and right support member 24. The aforementioned bolt may be further retained via nut members. Optionally, other suitable attachment devices may be utilized.

Lower left forwardly projecting leg 32 and lower right forwardly projecting leg 34 are preferably in sliding engagement with left support member 26 and right support member 24 respectively. In one embodiment, the lower left forwardly projecting leg 32 and lower right forwardly projecting leg 34 are connected to attachment brackets 46 which provide sliding movement along the elongated support members. Such connection may include bolts or other suitable attachment devices.

Upper left rearwardly projecting leg 36 and upper right rearwardly projecting leg 38 are preferably attached to the lift platform 16 via bolts or other suitable attachment devices. Upper left forwardly projecting leg 40 and upper right forwardly projecting leg 42 contain rollers 48 at an end thereof to allow each leg 40, 42 to traverse along the lift platform 16 as the scissors type extension extends to an extended position or collapses into a compact position.

Additional structure of the scissors type extension 12 may include cross member supports included, for instance, to provide additional support to parallel components of the upper and lower leg portions. Such cross members may further provide additional stability to the heavy duty vehicle component lift apparatus 10. One configuration may include ends of a lower forwardly projecting cross member 56 connecting to inner side surfaces of lower left forwardly projecting leg 32 and lower right forwardly projecting leg 34 near a connection point to the elongated support members. A weldment connection or other suitable attachment means may be utilized.

Likewise, ends of a lower rearwardly projecting cross member 58 may connect to inner side surfaces of lower left forwardly projecting leg 32 and lower right forwardly projecting leg 34 near a connection point of the upper and lower portion of the scissors type extension 12. A weldment connection or other suitable attachment means may be utilized.

Likewise, ends of an upper forwardly projecting cross member 60 may connect to inner side surfaces of upper left rearwardly projecting leg 36 and upper right rearwardly projecting leg 38 near a connection point of the upper and lower portion of the scissors type extension 12. A weldment connection or other suitable attachment means may be utilized.

Also, ends of a upper rearwardly projecting cross member 62 may connect to inner side surfaces of upper left rearwardly projecting leg 36 and upper right rearwardly projecting leg 38 near a connection point to the lift platform 16. A weldment connection or other suitable attachment means may be utilized.

Thus, in a preferred embodiment, the scissors type extension is extended and closed by a hydraulic cylinder and ram assembly 50 coupled to the support frame 14 and a component of the scissors type extension. Preferably, a support bracket assembly 52 is provided and attached to a cross member 60. A welded attachment may be utilized. Thus, the hydraulic cylinder and ram assembly 50 is coupled to the cross member 60 and to the support frame 14. Hence, an extension of the hydraulic cylinder and ram assembly 50 will extend the scissors type extension 12.

In order to power the hydraulic cylinder and ram assembly 50, a fluid power pump 54 is connected 64 thereto and powered by an electric motor 66 such as a ½ horsepower 115V motor. The motor 66 is preferably configured to a power cord 72 compatible with a standard 110V outlet assembly. The power cord 72 be comprise a retractable power cord, for example, located on a reel assembly for providing various lengths of cord.

The motor 66 may be controlled by a controller device 68. In one embodiment, the controller device 68 comprises a two-button remote on approximately a ten foot long cord. Such length may facilitate an operator to be located at many positions around the heavy duty vehicle component lift apparatus 10 as needed. The two button remote allows for up and down movement of the hydraulic cylinder and ram assembly 50 in order to raise and lower the lift platform 16 accordingly. A preferred power requirement for the heavy duty vehicle component lift apparatus 10 comprises components which support a 2500 lb load and/or lift capacity within a preferred lifting range of approximately 29 to 80 inches.

A lift table 74 may be configured to the lift platform 16, for example, in order to provide support to a component. The lift platform 16 is preferably configured to include a plurality of support members including a left lift platform support member 76 and a right lift platform support member 78. Each of the left lift platform support member 76 and right lift platform support member 78 comprises a front end which may be joined by a front cross lift platform support member 80. Likewise, each of the left lift platform support member 76 and right lift platform support member 78 comprises a rear end which may be joined by a rear cross lift platform support member 82. Additionally, a mid cross lift platform support member 84 is provided retained between the left lift platform support member 76 and right lift platform support member 78. Support members 76, 78, 80, and 82 of the lift platform 16 may be weldably connected or attached by other suitable means.

The lift table 74 is preferably adjustable to provide approximately 15 degrees of pivot in any direction. A plurality of trunnions and shafts are provided in the design to provide adjustability. A first threaded shaft 86 is threaded through a first trunnion 88 which is positioned on the a mid cross lift platform support member 84. The first threaded shaft 86 is supported on the lift platform 16 via rigid lift platform supports 90 and 92. Ends of the first threaded shaft 86 terminate in a hexagonal connector preferably compatible with standard socket wrench connections or speed wrenches. By turning an end of the hexagonal connector, the first threaded shaft 86 is threaded along and through the first trunnion 88 and the mid cross lift platform support member 84 is angularly adjusted.

The mid cross lift platform support member 84 further comprises a plurality of flange members 94, 96 at either end thereof. A second threaded shaft 98 is threaded there through in a perpendicular direction of the first threaded shaft 86. The second threaded shaft 98 is further threaded through a second trunnion 100 which is supported via a support assembly 102 by the lift table 74. Additional lift table support plates 104 and 106 connect the lift table 74 to the mid cross lift platform support member 84. The support plates 104 and 106 provide a pivot point for the second trunnion 100. Again, ends of the second threaded shaft 98 terminate with hexagonal connectors to support connectors such as socket wrench or speed wrench connections. Thus, turning the hexagonal connectors of the second threaded shaft 98 will pivot the lift table 74 angularly.

The lift table 74 is preferably designed to support and retain additional support members 108, 110. Such components may include wood members including 4×4 posts for example. The additional support members 108, 110 serve to provide additional cushioning to supported components other than the harder lift table 74 which could damage a surface finish of the support component. The lift table 74 provides a plurality of slots through which bolts (or other suitable fastening means) may be received in order to retain support members 108, 110 thereto. Additionally, support straps 112 may be utilized to retain components on the lift table 74.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for supporting and lifting a component comprising:
a first frame assembly;
a scissors type lift extension connected to the first frame assembly and support members, wherein the support members having a first threaded rod threaded through a first trunnion and a first and second rigid lift platform supports;
a lift table tiltably connected to the support members through the first trunnion, whereby the lift table is tiltably adjustable in a first direction; and
a hydraulic cylinder and ram assembly coupled to the first frame assembly and further coupled to the lift extension.

2. (canceled)

3. The apparatus of claim 21, wherein the lift table is tiltably adjustable in a second direction.

4. The apparatus of claim 1, wherein the hydraulic cylinder and ram assembly will accommodate a vertical lifting range from approximately 29 to 80 inches.

5. The apparatus of claim 1, wherein the apparatus supports a load up to approximately 2500 lbs.

6. The apparatus of claim 1, further comprising:
an electric motor;
a fluid pump coupled to the hydraulic cylinder and ram assembly, wherein the pump is powered by the motor; and a
a remote device for controlling the electric motor.

7. The apparatus of claim 6, wherein the electric motor comprises:
a retractable power cord.

8. The apparatus of claim 1, further comprising:
swivel casters connected to the first frame assembly.

9-11. (canceled)

12. The apparatus of claim 3, further comprising:
a second threaded rod trunnion assembly coupled to the lift extension for providing tiltable adjustment in the second direction.

13. The apparatus of claim 12, wherein the first threaded rod and the second threaded rod are configured perpendicular to one another.

14. A method for supporting and lifting a component comprising:
providing a first frame assembly;
coupling a lift extension to the first frame assembly and support members, wherein the support members having a first threaded rod threaded through a first trunnion and a first and second rigid lift platform supports;
coupling a lift table to the support members through the first trunnion, whereby the lift table is tiltably adjustable in a first direction; and
extending and/or retracting the lift extension via a hydraulic cylinder and ram assembly.

15. (canceled)

16. The method of claim 22, further comprising:
adjusting a tilt of the lift table in a second direction through the second trunnion.

17. A system for supporting and lifting a component comprising:
first means for supporting;
means for a scissors type lifting connected to the first supporting means and support members means, wherein the support member means having a first threaded means threaded through a first trunnion and a first and second rigid lift support means;
second means for supporting tiltably connected to the support member means through the first trunnion, whereby the second means for support is tiltably adjustable in a first direction;
means for extending the lifting means connected to the first support means and further coupled to the lifting means.

18. (canceled)

19. The system of claim 17, wherein the means for extending comprises a hydraulic cylinder and ram assembly.

20. The system of claim 17, wherein the second supporting means is tiltable in a first and second direction.

21. The apparatus of claim 1, wherein the lift table having:
a support assembly with a second trunnion, wherein a second threaded shaft is threaded through the second trunnion and a first and second support plates.

22. The method of claim 14, further comprising:
coupling the lift table to a support assembly having a second trunnion, wherein a second threaded shaft is threaded through the second trunnion and a first and second support plates.
